(19) United States
(12) Patent Application Publication
(10) Pub. No.: US 2003/0149648 A1
(43) Pub. Date: Aug. 7, 2003

(54) Method and system for measuring market conditions

(76) Inventors: Richard B. Olsen, Zurich (CH); Jorgen L. Olsen, Zurich (CH); Giles O. Zumbach, Zurich (CH); Michel M. Dacorogna, Zurich (CH)

Correspondence Address: PENNIE & EDMONDS LLP, 1667 K STREET NW, SUITE 1000, WASHINGTON, DC, 20006

(21) Appl. No.: 10/236,690

(22) Filed: Sep. 6, 2002

Related U.S. Application Data
(63) Continuation-in-part of application No. 09/842,438, filed on Apr. 26, 2001.
(60) Provisional application No. 60/200,742, filed on May 1, 2000.
(60) Provisional application No. 60/200,743, filed on May 1, 2000.
(60) Provisional application No. 60/200,744, filed on May 1, 2000.
(60) Provisional application No. 60/274,174, filed on Mar. 8, 2001.

(51) Int. Cl. G06F 17/60

(52) U.S. Cl. 705/35

(57) ABSTRACT

The present invention introduces two “event” scales for financial markets, called “scale of market shocks” (SMS), which measure the importance of the market movements. These indices are based on the price volatility and are computed by integrating mapped asset volatilities over time horizons that range from 1 hour to 42 days. The first SMS is an absolute scale, or universal scale, allowing values of different assets to be compared directly. The second SMS is an adaptive scale, calibrated to the typical behavior of each asset allowing the relative importance of market movements to be assessed. In principle, the SMS can be constructed for any market: the indices are computed from the price time series. In the foreign exchan9e (FX) market, each index is associated with a currency pair and we derive from it an index per currency and an index for the whole market.

In order to define the most appropriate SMS, the probability distribution for the volatilities is studied first. Then, the probability distribution of the two scales is computed. For USD/DEM and USD/JPY, the relations between peaks for the SMS and major “world events” is put forward. In addition, we also measure the correlation between the Scale of Market Shocks index and the size of the next price movements, which shows a high correlation for short time intervals.

### CROSS-REFERENCE TO RELATED APPLICATIONS

This application is a continuation-in-part of U.S. application Ser. No. 09/842,438, filed Apr. 26, 2001, which claims priority from U.S. Provisional Application No. 60/200,742, filed May 1, 2000; U.S. Provisional Application No. 60/200,743, filed May 1, 2000; U.S. Provisional Application No. 60/200,744, filed May 1, 2000; and U.S. Provisional Application No. 60/274,174, filed Mar. 8, 2001. The contents of the above applications are incorporated herein in their entirety by reference.

### BACKGROUND

For banks and other financial institutions, risk measurement plays a central role. Risk levels must conform to the capital adequacy rule. An error in the computed risk level may thus affect a bank's investment strategy. The state of the art is measuring risk by analyzing daily data: using one market price per working day and per financial instrument. In this description, the stochastic error of such a risk measure is demonstrated in a new way, concluding that using only daily data is insufficient.

The challenge for statisticians is to analyze the limitations of risk measures based on daily data and to develop better methods based on high-frequency data. This description meets this challenge by introducing the time series operator method, applying it to risk measurement and showing its superiority when compared to a traditional method based on daily data.

Intra-day, high frequency data is available from many financial markets nowadays. Many time series can be obtained at tick-by-tick frequency, including every quote or transaction price of the market. These time series are inhomogeneous because market ticks arrive at random times. Irregularly spaced series are called inhomogeneous, regularly spaced series are homogeneous. An example of a homogeneous time series is a series of daily data, where the data points are separated by one day (on a business time scale which omits the weekends and holidays).

Inhomogeneous time series by themselves are conceptually simple; the difficulty lies in efficiently extracting and computing information from them. In most standard books on time series analysis, the field of time series is restricted to homogeneous time series already in the introduction (see, e.g., Granger C. W. J. and Newbold P., 1977, Forecasting economic time series, Academic Press, London; Priestley M. B., 1989, Non-linear and non-stationary time series analysis, Academic Press, London; Hamilton J. D., 1994, Time Series Analysis, Princeton University Press, Princeton, N.J.) (hereinafter, respectively, Granger and Newbold, 1977; Priestley, 1989; Hamilton, 1994). This restriction induces numerous simplifications, both conceptually and computationally, and was almost inevitable before cheap computers and high-frequency time series were available.

### SUMMARY

U.S. Provisional Application No. 60/200,743, filed May 1, 2000, discloses a new time series operator technique, together with a computationally efficient toolbox, to directly analyze and model inhomogeneous as well as homogeneous time series. This method has many applications, among them volatility computations tick by tick and market condition assessment based on volatility computations.

The present invention comprises a system for measuring at least one market condition from at least one time series comprising:

one or more time horizons;

a measure fixing one or more weights of one or more contributions of said one or more time horizons from the time series;

an expression of volatility of the time series defined over said one or more time horizons;

a mapping of said expression of volatility over said one or more time horizons; and

an integral, taken over said one or more time horizons, of the product of said measure and said mapping for measuring the at least one market condition.

It is a further aspect of the present invention to present computer executable software code stored on a computer readable medium, the code for measuring at least one market condition from at least one time series, the code comprising:

code to define one or more time horizons;

code to define a measure fixing one or more weights of one or more contributions of said one or more time horizons from the time series;

code to define an expression of volatility of the time series defined over said one or more time horizons;

code to define a mapping of said expression of volatility over said one or more time horizons; and

code to determine an integral, taken over said one or more time horizons, of the product of said measure and said mapping for measuring the at least one market condition.

### BRIEF DESCRIPTION OF THE DRAWINGS

In FIG. 1, the measured probability distribution of the volatility is presented, together with a fit to the above theoretical distribution.

In FIG. 2, we plotted the χ and the χ² distribution with 16 degrees of freedom, the log-normal-distribution and the empirical pdf.

The theoretical probability distribution for the volatility and both mappings f are presented in FIG. 3.

In order to show the behavior of both scales of market shocks, FIG. 4 displays the indices Sᵤₙᵢ and S_{adp} for the USD/DEM and for DEM/CHF.

FIGS. 5 displays another illustration of the SMS indicator, showing its value for the USD/JPY market, from January 1997 to October 1998.

The empirical pdf's for both indices can be measured for different currency pairs. The result for USD/DEM is presented in FIG. 6, as well as a reasonable fit for both pdf(Sᵤₙᵢ) and pdf(S_{adp}) in the region of large S.

The procedure for computing the single currency index S[per] is illustrated in FIG. 7 for the DEM and USD, with a small currency basket.

The linear correlation coefficient is given in FIG. 8 for both models.

FIG. 9 discloses a representative computer system in conjunction with which the embodiments of the present invention may be implemented.

### DETAILED DESCRIPTION OF THE PREFERRED EMBODIMENT

1. The Time Series Operator Technique

In this description, only a minimum of a description of time series operators is given, so the applications of the following sections can be understood. The theory of the time series operators is explained in U.S. Provisional Application No. 60/200,743

1.1 Inhomogeneous Time Series

A time series z consists of elements or ticks zᵢ at times tᵢ. The sequence of these time points is required to be growing, tᵢ>tᵢ₋₁.

A general time series is inhomogeneous, meaning that the sampling times t₁ are irregular. For a homogeneous time series, the sampling times are regularly spaced, tᵢ−tᵢ₋₁=δt.

For some discussions and derivations, a continuous-time version of z has to be assumed: z(t). However, the operator methods that are eventually-applied only need the discrete time series (t₁,z₁).

The letter x is used to represent the time series of logarithmic middle prices, x=(ln p_{bid}ln pₐₛₖ)/2. This quantity is used in the applications.

1.2 Operators

An operator Ω, mapping from the space of time series into itself, is depicted in FIG. 1. The resulting time series Ω[z] has a value of Ω[z](t) at time t. Important examples are moving average operators and more complex operators that construct a time series of volatility from a time series of prices.

Linear and translation-invariant operators are equivalent to a convolution with a kernel ω:

$$Ω [ z ] ( t ) = {\int }_{- ∞}^{t} ω ( t - {t}^{′} ) z ( {t}^{′} ) ⅆ {t}^{′} \qquad ( 1 )$$

A causal kernel has ω(t)=0 for all t<0. No information from the “future” is used. If ω(t) is non-negative, Ω[z] is a weighted moving average of z whose kernel should be normalized:

$${\int }_{- ∞}^{t} ω ( t - {t}^{′} ) ⅆ {t}^{′} = {\int }_{0}^{∞} ω ( t ) ⅆ t = 1 \qquad ( 2 )$$

The kernel ω(t) is the weighting function of the past. FIG. 2 depicts an example of a causal kernel ω(t) of a moving average.

The range of an operator is the first moment of its kernel:

$$r = {\int }_{- ∞}^{∞} ω ( t ) t ⅆ t \qquad ( 3 )$$

This indicates the characteristic depth of the past covered by the kernel.

Operators are useful for several reasons, as will be shown. One important aspect is to replace individual ticks from the market by local short-term averages of ticks. This mirrors the view of traders who consider not only the most recent tick but also the prices offered by other market makers within a short time interval.

1.3 The Simple EMA Operator

The Exponential Moving Average (EMA) operator is a simple example of an operator. It is written EMA[τ; z] and has an exponentially decaying kernel (as shown in FIG. 3 which depicts a graph of the kernel, with τ=1):

$$ω ( t ) = ema ( t ) = \frac{{ⅇ}^{- t / τ}}{τ} \qquad ( 4 )$$

According to eqs. (3) and (4), the range of the operator EMA[τ; z] and its kernel is

r=τ (5)

The variable τ thus characterizes the depth of the past of the EMA.

The values of EMA[τ; z](t) can be computed by the convolution of eq. (1), if z(t) is known in continuous time. This implies an integration whose numerical computation for many time points t is costly. Fortunately, there is an iteration formula that makes this computation much more efficient and, at the same time, solves the problem of discrete data. This means that we do not need to know the whole function z(t); we just need the discrete time series values zᵢ=z(tᵢ) at irregularly spaced time points tᵢ. The EMAs are calculated by the following iteration formula:

EMA[τ; z](tₙ)=μ EMA[τ; z](tₙ₋₁)+(1−μ)z(tₙ)+(μ−υ)[z(tₙ)−z(tₙ₋₁)] (6)

with

$$μ = {ⅇ}^{- α} , α = \frac{{t}_{n} - {t}_{n - 1}}{τ} \qquad ( 7 )$$

$$v = \frac{1 - μ}{α} \qquad ( 8 )$$

This variableυis related to the problem of using discrete data in a convolution defined in continuous time. We need an assumption on the behavior of z(t) between the discrete time points t₁. Eq. (8) is based on the assumption of linear interpolation between points; other formulas for υ are implied by other interpolation assumptions, as explained in U.S. Provisional Application No. 60/200,743. In the case of assuming the value of the old tick for the whole interval before the new tick, the correct formula is

υ=1 (9)

For a homogeneous time series, μ and υ are constants. A homogeneous time series can alternatively be regarded as a truly discrete time series to which interpolation does not apply. This is mentioned here because it is a popular approach used by traders. For such a discrete time series, tₙ−tₙ₋₁ is defined to be 1, and the following definition is appropriate:

$$μ = v = \frac{1}{1 + α} = \frac{τ}{τ + {t}_{n} - {t}_{n - 1}} = \frac{τ}{τ + 1} \qquad ( 10 )$$

The range of an operator for a genuine discrete time series has a new definition:

$$r = {\sum }_{i = 0}^{∞} {ω}_{i} i .$$

For EMA, this means r=μ/(1−μ)=τ with ωᵢ=(1=μ)μ¹. The μ and υ values resulting from eq. (10) are very similar to those of eqs. (7) and (8) as long as α is small.

The iteration equation (6) is computationally efficient, extremely so when compared to a numerical convolution based on eq. (1). No other operator can be computed as efficiently as the simple EMA operator. However, there are means to use the iteration equation (6) as a tool to efficiently compute operators with other kernels, as shown below.

An iteration formula is not enough. We have to initialize EMA[τ; z] (t₀) at the start of the time series. For this, we can take z₀=z (t₀) or another typical value of z. This choice introduces an initial error of EMA[τ; z] (t₀) which decreases exponentially with time. Therefore, we also need a build-up period for EMA[τ; z]: a time period over which the values of EMA[τ; z] should not yet be applied because of their initial error. Build-up periods should be multiples of τ, e.g., 5τ. The choice of a large enough build-up period is discussed in U.S. Provisional Application No. 60/200,743.

1.4 The Operator EMA[τ, n; z]

Time series operators can be convoluted: a time series resulting from a an operator can be mapped by another operator. This is a powerful method to generate new operators with different kernels.

The EMA[τ, n; z] operator results from the repeated application of the same simple EMA operator. The following recursive definition applies:

EMA[τ, k; z]=EMA[τ; EMA[τ, k−1; z]] (11)

with EMA[τ, 1; z]=EMA[τ; z]. The computationally efficient iteration formula of the simple EMA, eq. (6), can again be used; we have to apply it recursively (n times) for each new tick (tᵢ, zᵢ). For v, we insert eq. (8) which is based on a linear interpolation assumption between ticks. (This assumption is just a good approximation in some cases, as discussed in U.S. Provisional Application No. 60/200,743.

The operator EMA[τ, n; z] has the following kernel:

$$ema [ τ , n ] ( t ) = \frac{1}{( n - 1 ) !} {( \frac{t}{τ} )}^{( n - 1 )} \frac{{ⅇ}^{- t / τ}}{τ} \qquad ( 12 )$$

This kernel is plotted in FIG. 4, which depicts graphs of selected EMA operator kernels, for several n (n=1 (thin), 2, 3, 4, and 10 (bold); left graph is for τ=1, right graph is for r=n τ=1). For large n (e.g., n=10 in FIG. 4), the mass of the kernel is concentrated in a relatively narrow region around a time lag of nτ. The corresponding operator can thus be seen as a smoothed backshift operator.

The family of functions of eq. 12 is related to Laguerre polynomials which are orthogonal with respect to the measure e^{-t} (for τ=1).

Operators, i.e., their kernels, can be linearly combined. This is a powerful method to generate more operators. Linear combinations of EMA[τ, n; z] operators with different n but identical τ values have kernels that correspond to expansions in Laguerre polynomials. This means that any kernel can be expressed as such a linear combination. The convergence, however, of the Laguerre expansion may be slow.

In practice, a small set of useful operators can be prepared with all the kernels needed. Aside from the discussed expansion, it is also possible to linearly combine kernels with different τ values. Some useful types of combined operators are presented in U.S. Provisional Application No. 60/200,743.

1.5 The Operator MA[τ, n; z]

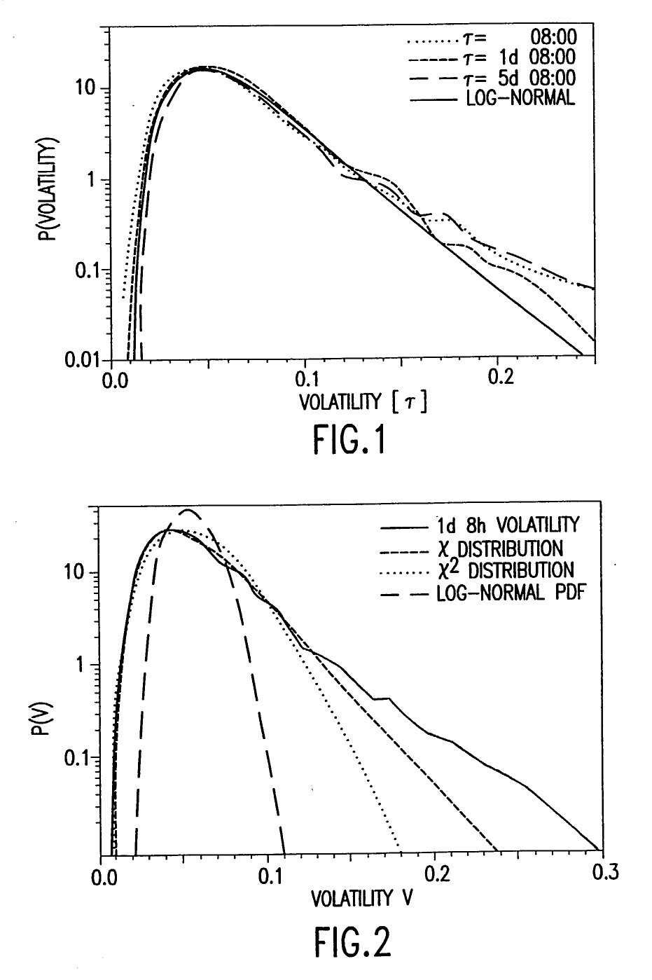

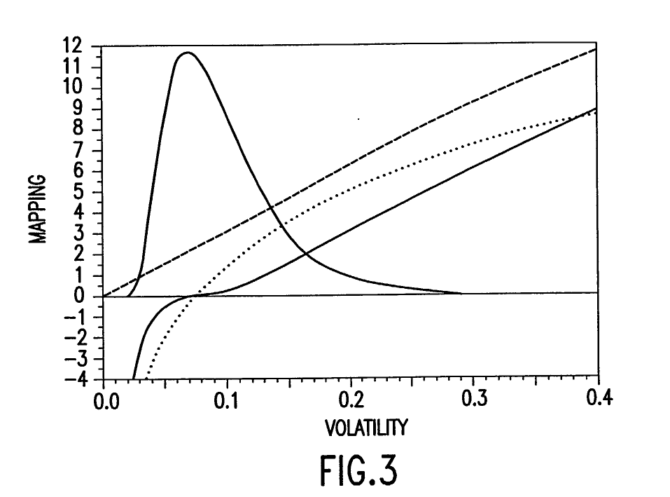

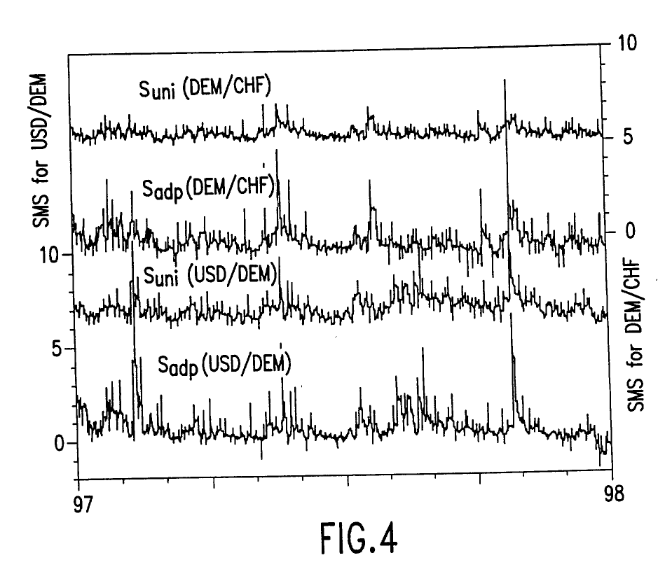

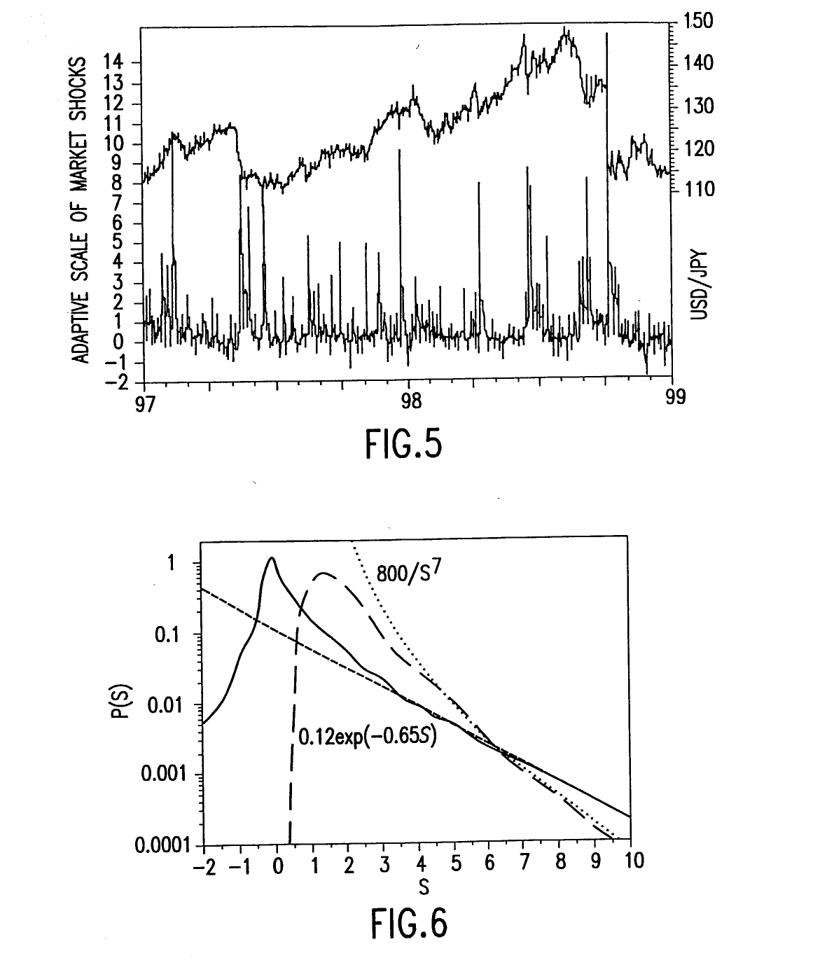

The moving average (MA) operator has kernels with useful properties as shown in FIG. 5, which depicts graphs of selected MA operator kernels (n=1, 2, 4, 8, and 16; τ=1). It is constructed as a sum of EMA[τ, n; z] operators:

$$MA [ τ , n ] = \frac{1}{n} {\sum }_{k = 1}^{N} EMA [ {τ}^{′} , k ] with {τ}^{′} = \frac{2 τ}{n + 1} \qquad ( 13 )$$

The variable τ′ is chosen such that the range of MA[τ, n] is r=τ, independent of n. For n=1, we obtain a simple EMA operator, for n=∞ the rectangularly shaped kernel of a simple moving average with constant weight up to a limit of 2τ. This simple rectangular moving average has a serious disadvantage in its dynamic behavior: additional noise when old observations are abruptly dismissed from the rectangular kernel area. Kernels with finite n are better because of their smoothness; the memory of old observations fades gradually rather than abruptly.

The formula for the MA[τ, n] kernel is

$$ma [ τ , n ] ( t ) = \frac{n + 1}{n} \frac{{ⅇ}^{- t / {τ}^{′}}}{2 τ} {\sum }_{k = 0}^{n - 1} \frac{1}{k !} {( \frac{t}{{τ}^{′}} )}^{k} \qquad ( 14 )$$

Many other kernel forms can be constructed through different linear combinations of EMA[τ, n; z] and other operators.

1.6 From Returns to Differentials

Most statistics in finance is based on returns: price changes rather than prices. Simple returns have a rather noisy behavior over time; we often want differences between local averages of x: smoothed returns.

Smoothed returns are computed by differential operators. Examples:

x—EMA[τ, n; x], where the EMA replaces x (t−τ). This is used by the application of section 3.2.

EMA[τ₁, n₁]−EMA[τ₂, n₂], with τ₁<τ₂ or n₁<n₂.

Δ[τ]=γ{EMA[ατ, 1]+EMA[ατ, 2]−2 EMA[αβτ, 4]}, with γ=1.22208, β=0.65 and α⁻¹=γ(8β−3). The is normalized, so Δ[τ, 1]=0, Δ[τ, t]=1. The kernel of this differential operator, described in U.S. Provisional Application No. 60/200,743, is plotted in FIG. 6, which depicts graphs of selected terms of a kernel of a differential operator Δ (full curve is kernel of Δ[τ] (τ32 1); dotted curve is the first two terms of the operator; dashed curve is the last term 2 EMA[αβτ, 4]).

The expectation value of squared smoothed returns may differ from that of the corresponding simple returns. This has to be accounted for when comparing the two concepts, for example in terms of a factor c in eq. (20).

1.7 Volatility Measured by Operators

Volatility is a central term in risk measurement and finance in general, but there is no unique, universally-accepted definition. There are volatilities derived from option market prices and volatilities computed from diverse model assumptions. In this description, the focus is on historical volatility: a volatility computed from recent data of the underlying instrument with a minimum of parameters and model assumptions.

For computing the time series of such a volatility, a time series operator is again the suitable tool. We first define the nonlinear moving norm operator:

MNorm[τ, p;z]={MA[τ;|z|^{p}]}^{1/p} (15)

This operator is based on a linear MA operator (where we are free to choose any positive, causal kernel); it is nonlinear only because a nonlinear function of the basic time series variable z is used. MNorm[τ, p; z] is homogeneous of degree 1.

The volatility of a time series x can now be computed with the help of the moving norm operator:

$$\begin{matrix}Volatility [ {τ}_{1} , {τ}_{2} , p ; x ] = MNorm [ \frac{{τ}_{1}}{2} , p ; Δ [ {τ}_{2} ; x ] & ( 16 ) \\ = {\{ MA [ \frac{{τ}_{1}}{2} ; \vert Δ [ {τ}_{2} ; x ] {\vert}^{p} ] \}}^{1 / p} & ( 17 )\end{matrix}$$

This is the moving norm of (smoothed) returns. With p=2, it is a particular version of the frequently used RMS value. However, some researchers had and have good reasons to choose a lower value such as p=1 in their special studies.

Eq. (17) is based on a moving average (MA) and a differential (Δ) operator. In principle, we may choose any MA and Δ operator according to our preference. In the applications of section 3, this choice is made explicit.

The volatility definition of eq. (17), as any definition of historical volatility, necessarily has two timing parameters:

1. the size of the return measurement intervals: τ₂;

2. the size of the total moving sample: τ₁, often >>τ₂; defined as the double range of the used MA. The MA operator has a range (center of gravity of the kernel) of τ₁/2.

2. Application: Volatility Computation and Market Condition Assessment

2.1 Introduction

The financial markets often experience large price movements. Such turbulence may bring great risk to the decision-making of financial institutions. Unfortunately, no attempt has been made to assess the risk level of these events other than a few cry from the media about ‘crash’ or ‘crisis’. In order to go beyond a heuristic analogy, there is a need to develop ways to measure the state of the financial market accurately and to provide quantitative assessment of market risk conditions. Such an objective assessment of the market state might help alleviate phenomena that often accompany ‘crises’ such as the widespread uncertainty over the reliability and stability of the financial system due to the strong interconnection between financial markets. An obvious illustration of a confidence crisis is provided by the recent events in Asia and Russia which culminated in August/September 1998.

Until now, there are no accepted ways of measuring how large the turbulence or shocks are to which the market is submitted. However, in other fields, there are well accepted scales to measure the strength of an event or a shock. A familiar example is the Richter scale in geophysics [Richter, 1958]. This scale is widely used and accepted to measure the intensity of an earthquake. In sailing, a similar scale exists, called the Beaufort scale, which measures the speed of winds and the state of the sea. The advantage of a well accepted scale is that shocks can be compared to each other and risk measures can be derived from them. A meaningful quantification is an essential step toward establishing an objective and testable relationship between different events. Moreover, if the scale is well designed, it can serve as a warning signal that the market is entering a turbulent state.

The present invention introduces a similar ‘event’ scale in financial markets which measures the importance of market movements. Such a measure provides a new analysis tool to the market, that is a new indicator. Due to the widely diverse characteristics of different financial assets, two scales are needed (they are presented in detail in section 5):

a universal scale which allows scale values for different assets to be compared directly and

an adaptive scale which is calibrated to the typical behavior of each individual asset.

These scales of market shocks, in short SMS, can be computed for any asset. In this paper, the emphasis of the empirical studies is on the foreign exchange market but the methodology can be applied with little modifications to other markets. In order for this scale to provide a useful measure, it is related to external events, or news, and calibrated on a wide range of these, ranging from ‘average’ market behavior to the most extreme cases.

Section 2.2 presents a brief description of the scale of market shocks. The formalism is included in section 2.3. In section 2.4, we define the volatility and study the properties of its probability distribution. The definition of the SMS for a particular FX-rate is given and discussed in section 2.5 while in section 2.8 the definition is extended to obtain a scale for the whole market. In section 2.7, we compare the index S with the news headlines in order to make a connection with actual events. Then, in the context of risk forecasting, we measure the correlation of the scale of market shocks with the size of the next price movements in section 2.9. The conclusions are presented in section 2.10.

2.2 Brief Description

As a first guideline, we can proceed by analogy with Richter's approach in the construction of his famous scale [Richter, 1958]. He defined a measure of the logarithm of the total energy liberated during an earthquake. As earthquakes are distributed with a power law probability distribution, the Richter scale also measures the (inverse) probability of an event. By analogy, we want to construct a logarithmic scale, namely a scale on which one more point corresponds to an event of the double intensity (more precisely, to a multiplication by a constant factor), or to an event which is twice as unlikely (more precisely, which is more unlikely by a constant factor). As we shall see below, these two definitions must be adapted for financial markets.

For the analogy with the Richter scale, we define the equivalent for financial markets of the concept of energy and total energy.

The energy: In mechanics, for a unit mass, the energy is given by

E=\vec{v}² where \vec{v}=d\vec{x}/dt is a speed, or a change of position per time interval. In finance, a possible analogy for the speed must be related to price changes. Price changes are created by an inbalance between buyers and sellers and correspond to the net flux of money. A price change is similar to a speed, i.e. to Dx(t)=(x(t)−x(t−τ))˜\vec{υ}, where x is the logarithmic middle price. However, with a stochastic process, we have one more parameter, namely the time range τ of the derivative D[τ]x . Then, the (mechanical) energy E, at a given time range τ, is given by E[τ]˜(D[τ]x)², i.e. the energy is related to a volatility measure. Therefore, we build the scale of market shocks from the instantaneous volatility, measured as an average over some time ranges of <(D[τ]x)^{2>}^{1/2}.

If more information is available, for example exchanged volumes, it could also be incorporated in the definition of the energy. Volume information is not presently known on the foreign exchange market since it is an over-the-counter market and there is no centralized place where transactions are recorded. The situation might change with the advent of automatic dealing systems. If this development becomes really significant and incorporates most of the market volume, another primary indicator could be used to build the SMS index, incorporating more information about the market.

The total energy: In an earthquake, the events are clearly separated: a beginning and an end can be identified, and the total energy released by an event can be integrated. The Richter scale corresponds then to the logarithm of the total energy. A financial process has a fundamentally different character, since it is dominated by the random component; a market is always fluctuating and moving, and this at all frequencies.

Therefore, we cannot identify “events”, with a clear beginning and end. The analogy with the Richter scale is limited here.

For a financial process, we want a continuous indicator, which is intuitively related to a total flux, or to the inbalance between buyers and sellers. In this sense, the mechanical work is a good physical analogy, since it is the rate of change of energy dE/dt.

The above discussion suggests to define the (instantaneous) scale of market shocks as the logarithm of the volatility at the time ranges r, integrated over the different time ranges. Therefore, we take the following form for the scale of market shocks indicator S:

S[μ, ƒ; x]=∫d ln τμ(ln τ)ƒ(υ[τ; x]) (2.1)

where the function ƒ(·) is appropriately chosen. The measure μ(ln τ) fixes the weight given to the contribution at different time horizons τ. A part of this measure has been included in the term d 1n τ, which reflects that the time range integral will be evaluated on a logarithmic scale. Formally, the limits of integration are from 0 to ∞, with some smooth cut-off included in the measure μ.

The present invention comprises an indicator sensitive to all market components, from intra-day dealers to long-term pension funds or central banks. That is why the integral is taken over ρ. Clearly, these different market participants look at the same price curve with different time horizons. A real shock happens when all market participants become involved. The τ integration is essentially summing over the market components and the indicator S becomes large when the volatility is large at all time scales. In physics, this is similar to a second order phase transition. These transitions are dominated by fluctuations at all length scales, leading to diverging quantities like the specific heat or the magnetic susceptibility. Studies of volatilities defined at different time horizons show their relatively small correlations. Moreover, we know that there are asymmetries in the information flow between volatilities measured at different frequencies [Miller et al., 1997]. These facts point to the relative independence and different information content of volatilities defined at different time horizons, and that there is no unique underlying volatility.

In order to turn this first form for S into a robust definition, we need to formalize the terms in eq. 2.1 precisely, namely

the derivative and volatility operators,

the form of the mapping function ƒ

and the measure μ.

As we are working with high frequency, real time data, which is not homogeneously spaced in time, a bit of sophistication is required here.

2.3 Notation and Computation of the Volatility

In this section, we present the notation, the basic definitions, and the main idea used for computing the volatilities.

Let us first fix the notation. Time series are denoted by a simple letter, like x. The value at time t of a time series x is denoted by x(t). If a time series depends on a parameter p, it is denoted within brackets x[p]. If an indicator S is computed from another time series x, it is denoted by S[p; x]. For example, the scale of market shocks indicator S[μ; x] for a time series x depends on the measure μ. For a linear operator, we also use the notation D[p; x]=D [p]x, to make the linearity properties explicit.

Tick-by-tick (high frequency) data contains a time stamp t and the bid and ask prices P_{bid}, Pₐₛₖ [Müller et al., 1990]. We will consider the logarithmic middle price x as our primary time series

$$x = \frac{1}{2} \{ ln ( {p}_{bid} ) + ln ( {p}_{ask} ) \} \qquad \text{(3.2)}$$

The annualized return in a time interval r is then given by

$$r [ r ; x ] ( t ) = \frac{x ( t ) - x ( t - τ )}{\sqrt{τ / 1 y}} . \qquad ( 3.3 )$$

The denominator is here to remove the Gaussian random walk scaling E [(x(t)−x(t−τ)) ²]˜τ. With such a definition, E [r[r]²]=σ², with σ independent of r is a very good approximation as we will see. The time interval τ is expressed in some time unit. We choose years as units, denoted by the symbol 1y so that the returns are annualized.

The volatility v at the time scale τ of a time series x; can be measured by

$$v [ τ ; x ] ( t ) = \sqrt{\frac{1}{16} {\sum }_{i = 1}^{16} {( r [ τ / 16 ; x ] ( {t}_{i} ) )}^{2}} \qquad ( 3.4 )$$

with tᵢ=t−(i−1)τ/16. This corresponds to an annualized volatility, because the return is already scaled by 1/τ. As discussed in detail in [Zumbach and Muller, 2000], these last two formulae suffer from a number of drawbacks, particularly when working with high frequency data. Therefore, we instead measure the volatility with an equivalent formula based on exponential moving average (EMA) technology:

υ[r; x]=MNorm[τ/2, p=2; D[τ/16; x]] (3.5)

The D operator computes a return similar to 3.3, but using a smooth kernel built with an appropriate combination of EMA operators. The MNorm[τ,p] operator computes a moving p norm in a window of length≅2r. Usually, p=2 is taken, but we will also use \acute{p}=½ below in order to have a more robust measure for the average volatility.

A further problem is the treatment of daily and weekly seasonalities. This is a major issue as we are working in the intra day time range and because volatilities exhibit strong seasonalities [Müller et al., 1990, Baillie and Bollerslev, 1990]. Without properly accounting for these effects, we would obtain a peak every European afternoon, corresponding simply to the trivial overlap of the European and American markets. For this reason, the above computations are done in the theta-time scale, as introduced by [Dacorogna et al., 1993].

2.4 The Probability Distribution for the Volatility

It is generally assumed that the log-normal distribution is a good approximation for the probability distribution of volatility

$$p ( v ) = \frac{1}{\sqrt{2 π} σ v} exp [ - \frac{1}{2 {σ}^{2}} {( ln \frac{v}{{v}_{0}} )}^{2} ] \qquad ( 4.6 )$$

The maximum of the distribution is reached at vₘₐₓ=υ₀exp(−σ²). Expressing this probability distribution in terms of the parameter υₘₐₓ instead of υ₀, we obtain the less familiar but more convenient expression

$$\begin{matrix}p ( v ) = \frac{1}{\sqrt{2 π} σ {v}_{max}} exp [ - \frac{1}{2 {σ}^{2}} {( ln \frac{v}{{v}_{max}} )}^{2} - \frac{{σ}^{2}}{2} ] & \text{(4.7)} \\ = {p}_{max} exp [ - \frac{1}{2 {σ}^{2}} {( ln \frac{v}{{v}_{max}} )}^{2} ] . & \text{(4.8)}\end{matrix}$$

This form is easier to work with than eq. 4.6. The mean of the log-normal probability density is

\overline{υ}=υₘₐₓexp(3σ²/2). (4.9)

In FIG. 1, the measured probability distribution of the volatility is presented, together with a fit to the above theoretical distribution. Clearly, the agreement is excellent for the center of the distributions. It is only in the tail that the observed probability is systematically larger than the theoretical distribution. This is due to the fat tailedness of the return pdf, namely to the fact that p(r) decays as 1/r^{a+1} with a tail exponent a 3.5 [Müller et al., 1998]. Heuristically, the fat tail of p(r) must translate in a fat tail distribution for p(υ) with the same tail exponent. This is not correctly captured by the log-normal pdf. Note also that the Gaussian random walk scaling makes the probability distribution almost invariant when changing the time range rjustifying the volatility definition of eq. 3.5.

Fitting the volatility pdf with other ‘classical’ probability densities (χ, χ², F-distribution, Weibull, Fisher-Tippett), does not provide as good a fit as the log-normal. This can be understood partly by the following argument. The log-normal pdf can be rewritten in the form

$$\begin{matrix}p ( v ) = {{p}_{max} ( \frac{{v}_{max}}{v} )}^{k ( v )} & \text{(4.10)} \\ k ( v ) = \frac{1}{2 {σ}^{2}} ln \frac{v}{{v}_{max}} & ( 4.11 )\end{matrix}$$

For large υ, this law decays faster than any power, but much slower than an exponential or a Gaussian. All the classical pdf's decay too fast, like an exponential or a Gaussian, except the F-distribution which overall does not fit the data well. We modify the form of k(υ) by introducing a saturation at the approximate tail exponent value α+1≅4.5. We then obtain a good overall fit for the volatility pdf, for example with the form

$$k ( v ) = \frac{1}{2 {σ}^{2}} ln ( \frac{1}{{( {v}_{max} / v )}^{P} + exp ( - 2 p {σ}^{2} ( α + 1 ) )} ) \qquad \text{(4.12)}$$

with p=2 to p=4. Yet, the cross-over from log-normal to power law behavior seems to be asset dependent. For example, the USD/JPY shows much more tail than DEM/CHF. Without a theoretical hint, such modifications of the theoretical pdf are an ad hoc solution, which introduces new parameters. Therefore, we prefer to keep the simpler log-normal form for the volatility distribution.

A puzzling feature of this fit is that the log-normal pdf has two parameters (υₘₐₓ, σ), whereas the return pdf has only one scale parameter measuring the width of the distribution. It appears that we have one additional parameter in p(υ). For the sake of argument, let us assume that the return pdf is a Gaussian of width v₀. The standard deviation (volatility) v is defined as v=\sqrt{1/nΣr₁²}, and is distributed as a resealed χ pdf n/υ₀χ[n](υn/υ₀) (a χ distribution because of the square root in the definition of v, and rescaled because of the factor 1/n and υ₀). This distribution has two parameters n and v₀, yet the parameter n is fixed by the definition of υ. Essentially, for the rescaled distribution, the center of the distribution measures υ₀ and the width depends on n. The same phenomenon occurs with the log-normal pdf, where υ₀ measures the width of the return pdf, and σ depends on the volatility definition. To check for this, we have fitted a log-normal pdf to the empirical distribution of υ for many currency pairs, with different υₘₐₓ but the same σ=0.4. All the fits are excellent up to the tails and confirm that there is indeed only one free parameter. Therefore, we have fixed Γ=0.4. It is important to understand that since we need to fit many distributions for many different assets, the methodology should be parsimonious and it is a success when we can avoid introducing more parameters.

It is tempting to go one step further and to relate 6 to the number of degrees of freedom used in the volatility definition (in our case this number is 16). In FIG. 2, we plotted the χ and the χ² distribution with 16 degrees of freedom, the log-normal distribution and the empirical pdf. Unexpectedly, given the above argument, the χ distribution is very far from the empirical one. The χ² does better, but the tail is still not fat enough. The best fit is clearly achieved by the log-normal pdf.

A related puzzling feature is the lack of ‘central limit theorem’. A one day return is the sum of many returns at a smaller time scale and, if these returns are independent, the condition for the central limit theorem are fulfilled (the tail index must also be larger than 2, which is true at least for FX). The returns are not independent because of the ARCH effect, but empirically, the return pdf p(r[δt]) indeed converges towards a Gaussian law with increasing time horizon δt. This fact tells us that the serial dependency in the returns is weak enough for the central limit theorem to apply. Therefore, we might expect the volatility pdf to converge toward a χ distribution with increasing time horizon. Empirically, this is certainly not the case and the empirical volatility distribution instead shows a very remarkable stability with time aggregation. This is probably due to the strong dependency seen in the autocorrelation of absolute returns [Dacorogna et al., 1993, Ding et al., 1993]. It is also interesting to relate the volatility distributions with the one of a GARCH(1,1) process. The aggregation law of the GARCH(1,1) process have been derived by [Drost and Nijman, 1993], and essentially the volatility pdf converges toward its mean when aggregating (i.e. the pdf converges toward a delta distribution). This is clearly different from the above findings. Moreover, the other GARCH(1,1) parameters fitted at different time horizons do not seem to follow the aggregation law of the GARCH model [Guillaume et al., 1994, Andersen and Bollerslev, 1997]. It is a further confirmation that volatility must be measured with different frequencies as argued in the discussion of eq. 2.1.

2.5 Definition of the Scale of Market Shocks S

In order to fully define the scale of market shocks by the formula 2.1, we must choose the measure μ(ln τ) and the mapping function ƒ.

For the measure μ(ln τ), we take a smooth function, centered at τ_{center}, and decaying toward the short and long time intervals. The exact analytical form does not play an important role. Here, we take

x₋=−α₋ln(τ/τ_{center}) for τ−τ_{center}

x₊=α_{+ln(τ/τ}_{center}) for τ>τ_{center}

μ(ln τ)=ce^{-x}(1+x+x²/2) for x=x_{±} (5.13)

The parameters α₋ and α₊ control the decay of the measure for, respectively, the small and larger τ. The constant c is adjusted so that μ is a unit measure ∫d ln τ μ(ln τ)=1. The results presented below are computed with α₌α₊=2. Practically, the integral over τ has a cut-off at 1 hour on the low limit and 42 days on the high limit. Since the measure is very small at the integration limit, it does not really influence the result of the integral. The value of τ_{center} is more important and a value around one day gives good results. The parameter τ_{center} is crucial since it controls the time response of the indicator.

In order to construct a good indicator, the form of the function is very critical. Following a direct analogy with the Richter scale, we first took

ƒₗₙ(υ)=ln(υ/υₘₐₓ). (5.14)

This led to quite a poor indicator, as turbulent markets are not clearly above the normal fluctuating market. In other words, this form for f does not differentiate enough between exceptional events and background fluctuations. A better form for the mapping function can be derived by transforming the usual form of the Richter scale. Empirically, the observed probability of an earthquake with energy E decays as a power law

$$p ( E ) ≃ {( \frac{{E}_{0}}{E} )}^{k} \qquad \text{(5.15)}$$

Using this probability distribution, we can rewrite the Richter scale R as

$$R ≃ ln ( \frac{E}{{E}_{0}} ) = \frac{1}{k} ln ( \frac{1}{p ( E )} ) \qquad ( 5.16 )$$

In this form, the Richter scale is expressed as the logarithm of the (un)likelihood of an event with energy E. This suggests the following form for the mapping ƒ

$$\begin{matrix}{f}_{adp} ( v ) = sign ( v - {v}_{max} ) ln ( \frac{{p}_{max}}{p ( v )} ) \\ = sign ( v - {v}_{max} ) \frac{1}{2 {σ}^{2}} {( ln \frac{v}{{v}_{max}} )}^{2}\end{matrix} \qquad ( 5.17 )$$

where, in the last equality, we use the fit of the previous section for the probability distribution p(υ). These two definitions for ƒ eq. 5.14 and eq. 5.17 lead to different indicators, because for financial data the probability distribution of the volatility υ is not a power law, contrary to the underlying process of the Richter scale. The theoretical probability distribution for the volatility and both mappings f are presented in FIG. 3. We clearly see why the second definition is working well: the range of normal volatilities around the maximum υₘₐₓ, are mapped closely to zero, and therefore are scaled down. On the other hand, the mapping is very linear in the large volatility region, extracting the important events from the noise. The mapping 5.17 acts as a non linear amplifier that extracts the signal we want from the normal volatility level. This construction is efficient because financial data are dominated by the white noise component. In this respect, finance is very different from geophysics, where seismograph recordings show with great clarity the passage of the various sismic waves.

In eq. 5.17, we use the fit for the volatility pdf. Improving on this fit could lead to a better mapping. As argued before, we prefer to keep a simple log-normal pdf in order to avoid introducing new asset dependent parameters in this fit. Compared to empirical data, the log-normal pdf underestimates the tail probability. In turn, this gives too much weight to large events compared to ƒ(υ)˜1n pₘₐₓ/p(υ). As we are precisely interested in extreme events, it is indeed a good feature to slightly overemphasize large volatilities.

As argued above, the parameter σ is fixed by our volatility definition and therefore does not depend on the asset. Yet, the parameters vₘₐₓ introduces an explicit dependency on the asset in the definition of S. Here we reach a difference between geophysics and finance: there is only one earth and one Richter scale whereas different assets are like different planets. It is intuitively clear that the USD/DEM experiences more fluctuations and shocks than DEM/CHF, and the difference is even larger, say, between FX and interest rates. At this point, two approaches are possible:

Compare the scale of market shocks values for various assets. For this purpose, a universal SMS is needed.

We are interested in individual assets and want a scale calibrated to each asset behavior. For this purpose, an adaptive SMS is needed.

As both approaches have their respective merits, let us introduce two scales of market shocks the universal SMS Sᵤₙᵢ, and the adaptive SMS S_{adp}.

The universal SMS Sᵤₙᵢ

The mapping (5.17) is almost linear for the large volatilities in which we are mainly interested. Therefore, a simple linear mapping already provides a good scale of market shocks

ƒᵤₙᵢ(υ)=sυ. (5.18)

The slope s is chosen so that an asset with a 10% annual volatility has comparable SMS differential values in both scales at υ=3υₘₐₓ

$$s = \frac{ⅆ {f}_{adp} ( v )}{ⅆ v} {\vert}_{v = 3 {v}_{max}} = \frac{ln ( 3 )}{{σ}^{2} 3 {v}_{max}} = 29.1 \qquad ( 5.19 )$$

with \overline{υ}=0.1, υₘₐₓ=\overline{υ}exp(−3σ²/2), and ƒ(v) given by eq. 5.17. With this mapping, the background normal volatilities \overline{υ} give a value Sᵤₙᵢ=s\overline{υ} depending on the asset.

The adaptive SMS S_{adp}This scale is defined with the mapping (5.17). Yet, for each asset, this mapping depends on the mean volatility \overline{υ} which has to be estimated. Moreover, this quantity is not constant over a time scale of a few years. For example, the intra European FX market has a decreasing volatility since the beginning of the '70s and a large event in 1998 for DEM/FRF seen in the adaptive SMS is certainly much smaller in the absolute SMS. Therefore, the mean volatility \overline{υ} is like an adiabatic, slowly changing quantity, namely it is a time series. We measure \overline{υ} with

\overline{υ}=∫d ln τμ(ln τ)MNorm[90d, p=½; υ[τ; x]] (5.20)

The τ integration and the measure are as for the definition of the SMS. The MNorm operator [Zumbach and Müller, 2000] computes a moving norm with τ=90 days, corresponding approximatively to a (rectangular) moving window of length 180 days. The norm is computed with an exponent p=½ in order to decrease the importance of the large volatilities and to obtain a more robust estimate of the mean volatility.

With this definition for \overline{υ} and the relation 4.9, we now have a complete definition for the adaptive SMS S_{adp}.

The possible gaps in the data source lead to a fictitious small value for the volatility. Because of the logarithm in the mapping ƒ, data gaps would produce negative diverging values for ƒ, given in turn a strongly negative SMS indicator S. In order to avoid this problem being due to the data source, the mapping is bounded below, namely if υ<υₘᵢₙ then ƒ_{adp}(υ) ƒ_{adp}(υₘᵢₙ). In the present computations, we take vₘᵢₙ=\overline{υ}/3.

For the software implementation, the value of the volatility υ[τ] is updated with every tick of the market. Then, after every time interval ΔT, the index S is computed. The integral over τ is computed on a regular logarithmic grid, ranging from 1 hour to 42 days, with a reason of 2^{1/4}. The statistical properties of S can then be studied from this regular time series. Furthermore, in order to compute the probability distribution for the volatilities and for S, the weekends have been removed.

2.6 An Empirical Study

In order to show the behavior of both scales of market shocks, FIG. 4 displays the indices Sᵤₙᵢ and S_{adp} for the USD/DEM and for DEM/CHF. These particular currencies pairs are selected because the CHF is strongly correlated with the DEM, therefore a very low level of volatility is expected. Both adaptive scales have zero as their base lines, and show comparable peak heights. Clearly, the adaptive mechanism put into ƒ_{adp}(υ) is working. Yet, 30 the overall lower volatility of DEM/CHF is clearly visible on Sᵤₙᵢ with a base line of ˜1, whereas the base line for USD/DEM is ˜2. The peak heights is also much smaller for DEM/CHF, in line with our expectation for a direct comparison of these currencies pairs.

FIGS. 5 displays another illustration of the SMS indicator, showing its value for the USD/JPY market, from January 1997 to October 1998. We choose this example because 1997 and 1998 were eventful years for the JPY and it is recent enough so that the reader may remember the events causing the peaks (hint: some events are due to other currencies, like the Thai Baht). For the adaptive SMS S_{adp}, the non-linear transformations is working very well, as peaks distinguish themselves clearly from the background fluctuations. It should also be emphasized that the volatilities used to compute S are mostly not visible on the price curve. The volatilities with the largest weight corresponds to intra-day fluctuations and on this graph there are only 6 points per day ΔT=4 hours. Therefore, the scale of market shocks really brings out new information, not visible in the price curve.

We also study the dependency of S on the center of the measure τ_{center}. The main conclusion is that varying τ_{center} from 12 hours to 48 hours does not significantly change the results. As can be expected, by taking a smaller τₑₙₜₑᵣ, the peaks tend to be slightly narrower and higher. In the previous graph, the only exception are the high narrow peak in February and the two small narrow peaks in July 1997: those peaks appear to be dominated by very short intra day fluctuations.

The empirical pdf's for both indices can be measured for different currency pairs. The result for USD/DEM is presented in FIG. 6, as well as a reasonable fit for both pdf(Sᵤₙᵢ) and pdf(S_{adp}) in the region of large S. The functional form of the fits is not necessarily the best for this particular currency pair, but provides a reasonable fit for all currency pairs. The asymptotic properties of the pdf for the universal index is well described by a power law decay, with an exponent varying from 5.5 to 7. This is consistent with the functional form of the definition and with the asymptotic decay for the return pdf, but with slightly larger tail exponents. Yet, the value of the decay exponent should be taken with care when comparing to a tail exponent, because we only applied a fit for the large S region and not a proper tail estimate. The pdf for S_{adp} is well approximated by the exponential form exp(—αS_{adp}), with a coefficient α between 0.55 to 0.75. This is roughly consistent with the rule of thumb that one more point on the (adaptive) scale of market shocks corresponds to an event that is twice as unlikely. Yet the precise values are asset dependent. This result justifies a posteriori the argument and mapping used to construct the adaptive scale.

2.7 Event Study for Two FX-Rate Scales

To illustrate the quality of the scale, we choose to compute it for USD/JPY and USD/DEM from January 1997 to September 1998. These particular months were full of events in East Asia and, by contrast, relatively calm in Europe. Thus comparing the two behaviors should give us an idea whether the reality is well described. In Tables 1 and 2, we report all the days where the universal SMS for USD/JPY or for USD/DEM were above 3.0. There are close to 40 of these days for USD/JPY over 19 periods (some consecutive days) while there are only 17 over only 8 periods for USD/DEM. To find the events corresponding to the peaks, we looked among the money market news headlines of Reuters (AAMM page) and in the magazine “The Economist” for reports of particular news during those days. The From the table, it is clear that the rumors of the intervention of the Bank of Japan, which we found publicized in Reuters headlines, had a significant impact on the scale together with the major events that hit the Japanese market, which were reported both in “The Economist” and on Reuters. The highest value (9.9) was reached on Dec. 17, 1997 after the announcement of the government plan to restore stability. This plan was a big disappointment for investors and the sentiment over the authorities' failure to get out of the financial crisis became very strong. In contrast, the JPY was comparatively less affected by the October crisis on the Asian stock markets.

TABLE 1
Table summarizing all the dates where the universal SMS for either
USD/JPY or USD/DEM were above 3 and the related events, as
found in “The Economist” and in the monetary news headlines of
Reuters. The second and the third column report the highest
value reached by the SMS during that day
for USD/JPY and USD/DEM respectively.
An empty entry means that the scale was below 3.

| Date | JPY | DEM | News |
|---|---|---|---|
| Feb. 08, 1997 | 5.9 | 3.5 | Article in the Economist from Feb. 15-21 |
| | | | (P. 79): problems with Nippon |
| | | | Credit and Hokkaido Takushoku bank. |
| | | | “Nippon Credit admits 11.4 |
| | | | billions USD in bad loans analysts |
| | | | think it is the double”. |
| Feb. 09, 1997 | 5.9 | 3.4 | |
| Feb. 10, 1997 | 9.1 | 5.6 | Rumors of BOJ (Bank of Japan) |
| | | | intervention for 500 bin JPY. The |
| | | | Bundesbank sets the REPO rate at 3%. |
| May 09, 1997 | 5.1 | | Thai Baht crisis. Saved from |
| | | | devaluation by central |
| May 10, 1997 | 4.9 | | bank interventions. |
| May 11, 1997 | 4.8 | | |
| May 12, 1997 | 7.1 | | Rumors of BOJ intervention for |
| | | | 400 bin JPY. |
| May 21, 1997 | 5.8 | 4.5 | Comments of BOJ deputy governor |
| | | | in parliament. |
| Jun. 09, 1997 | 4.8 | | Rumors of BOJ intervention for |
| | | | 100 bin JPY. Bank of Korea intervenes in |
| | | | inter-bank market, buys. |
| Jun. 11, 1997 | | | Rumors of BOJ (Bank of Japan) |
| | | | intervention for 300 bin JPY. |
| Jun. 12, 1997 | 8.0 | | |
| Jun. 13, 1997 | 4.6 | | Japan prosecutors arrest |
| | | | DKB (Daichi Kangyo) |
| | | | vice president |
| Aug. 08, 1997 | 6.1 | | Taiwan dollar sinks to 28.739 at close. |
| Aug. 09, 1997 | 5.4 | | |
| Aug. 10, 1997 | 5.4 | | |
| Aug. 11, 1997 | 5.3 | | |
| Aug. 26, 1997 | 4.7 | | The Bundesbank leaves the REPO |
| | | | rate unchanged contrary to |
| | | | market expectations |

Similarly, the few days where the scale was high for the USD/DEM are, as expected, related to the stock exchanges turbulences after the Hang Seng crash at the end of October 1997 and also in August 1998. In October 1997 the Hang Seng crash also affected the European and American exchanges (the DAX was down 6.6% on October 28). The scale reaches its peak (6.1) for 1997 on October 28 during the Asian exchange crisis. The SMS for USD/DEM is also quite sensitive to the Bundesbank changing or keeping the REPO rate (second largest SMS 5.6 in February 1997 when the Bundesbank set the REPO rate to 3%).

There is a substantial body of literature on the relations between news and market movements. Generally, the relation is found to be very small or non existent. Most of these papers use low frequency data (daily, sometime hourly), look at price differences (return) and focus on economic news. The major difficulty is to obtain an a priori quantitative estimate of the announcements, possibly separating and quantifying the expected and unexpected part of announcements. An illustration of this problem is given by the resignation of the governor and the deputy governor of the bank of Japan on Mar. 20, 1998 which resulted in a magnitude of 2.2 on the SMS. The reason for this relatively small movement is probably the fact that these resignations were largely expected after all the turmoils of the previous year, and dealers had probably already discounted the news. In a recent paper, Almeida, Goodhart and Payne [Almeida et al., 1998] studied the correlation between high frequency price movements and the unexpected part of macroeconomic announcements for USD/DEM. They find a small (at most 30 basis points) but significant impact for most announcements, on very short time horizon (15 minutes). The correlations decay rapidly with increasing time horizons, and is unobservable at one day. In the conclusion, they conjecture that from the macroeconomic news, the unexpected changes in interest rates should produce the largest responses on the exchange rates. This is indeed what we observe in Tables 1 and 2. Compared to the bulk of the literature, the present approach is different as we focus on high frequency volatility at different time horizons. This allows us to obtain clear signals and a convincing relation between large values for the SMS indexes and major events. Yet, a quantitative study of the correlation with the unexpected part of the news remains to be done. The major obstacle is in quantifying the expected and unexpected part of news for a broad spectrum of events.

TABLE 2
Table summarizing all the dates where the universal SMS for either
USD/JPY or USD/DEM were above 3 and the related events, as found in
“The Economist” and in the monetary news headlines of Reuters
(continuation from Table 1). The second and the third column report the
highest value reached by the SMS during that day for USD/JPY and
USD/DEM respectively. An empty entry means that the
scale was below 3.

| Date | JPY | DEM | News |
|---|---|---|---|
| Sep. 09, 1997 | 4.9 | | USD hit by fears of US/Japan trade |
| | | | tensions. |
| Sep. 09, 1997 | 6.3 | | Resignation of the chairman of |
| | | | Daiwa Securities. |
| | | | Arrest of a former |
| | | | president of Yamaichi. |
| Oct. 10, 1997 | 6.0 | 6.1 | Stock crash originating in Asia |
| | | | (HSI −13.7%, DJI −7.2%, DAX −6.6%). |
| Oct. 10, 1997 | 4.5 | 4.8 | |
| Nov. 17, 1997 | 5.5 | | Collapse of Hokkaido Takushoku Bank |
| | | | (10th largest com. bank). |
| Dec. 17, 1997 | 9.9 | | Announcement of the government |
| | | | “measures to restore the path of |
| | | | stability”. The investors are |
| | | | disappointed by |
| | | | the low tax cut announced. |
| | | | The BOJ is said to intervene with |
| | | | more than 1 bln USD. |
| Dec. 18, 1997 | 4.8 | | The BOJ is believed to be selling USD at |
| | | | 127.50/60. The grain brokerage |
| | | | firm Toshoku files for bankruptcy. |
| Jan. 08, 1998 | 3.6 | | Hong Kong Peregrine's bankruptcy. |
| | | | Indonesian Rupiah Crisis. BOJ |
| | | | intervention after JPY decline. |
| Jan. 26, 1998 | | 4.5 | Possible Clinton's affair with a |
| | | | former White House employee is made |
| | | | public on internet. |
| Apr. 09, 1998 | 7.5 | | BOJ announces intervention: |
| | | | selling USD in New York. |
| Apr. 10, 1998 | 9.1 | | Analysts think that BOJ spent 5 |
| | | | bin USD in the last two days. BOJ |
| | | | disciplines 98 staff members for |
| | | | “entertainment”. |
| | | | BOJ officials admit |
| | | | leaking internal information to contacts. |
| Apr. 13, 1998 | 5.2 | | Announcement of Japan trade surplus |
| | | | that jumps up 97.1%. |
| May 10, 1998 | | 5.1 | The SPD admits that it could rule |
| | | | with communists |
| May 11, 1998 | | 5.5 | India tests an atomic bomb |
| Jun. 16, 1998 | 6.2 | | |
| Jun. 17, 1998 | 9.0 | | Joint intervention of Bank of Japan and |
| | | | US Federal Reserve |
| Jun. 18, 1998 | 7.8 | | |
| Jun. 19, 1998 | 6.2 | | |
| Jun. 20, 1998 | 7.4 | | G7 Meeting on Asia Crisis |
| Jun. 21, 1998 | 7.6 | | |
| Jun. 06, 1998 | 8.6 | | USD again up on disappointment |
| | | | from the G7 meeting |
| Jul. 13, 1998 | 6.7 | | Hashimoto's defeat at the election |
| Aug. 28, 1998 | 5.6 | 3.7 | Turmoil on the stock markets |
| Aug. 29, 1998 | 3.6 | | |
| Aug. 30, 1998 | 3.5 | | |
| Aug. 31, 1998 | 4.4 | | |
| Sep. 01, 1998 | 6.4 | 4.2 | |
| Sep. 02, 1998 | 5.3 | 3.3 | |
| Sep. 04, 1998 | 5.7 | 3.4 | |

2.8 From a FX-Rate Scale to a ‘Grand’ Market Scale

The scale of market shocks can be constructed in principle for any market: the index is computed from the price time series. In the foreign exchange (FX) market, an index S[per/exchanged] is associated to each currency pair. Yet, in the case of the FX market, it is 30 interesting to derive an index per currency. For example, when S[USD/JPY] is large, you cannot determine if the turbulence is originating in the U.S. or in Japan. By considering more currency pairs, like USD/DEM, USD/GPB, USD/JPY, etc . . . , the USD part can be isolated. By summing currency pairs, the contributions of one country is enhanced while reducing the effect of the other currencies. A single currency index S [per] for the ‘per’ currency is computed by summing the S[per/exchanged] index for currency pairs ‘per/exchanged’ with respect to the ‘exchanged’ currency. Each currency pair in the sum is weighted by its estimated relative importance.

This procedure is illustrated in FIG. 7 for the DEM and USD, with a small currency basket. The weights for the single currency SMS are

USD=0.3 USD/DEM+0.3 USD/JPY+0.2 GBP/USD+0.1 USD/CHF

DEM=0.4 USD/DEM+0.3 DEM/JPY+0.2 GBP/DEM+0.1 DEM/CHF

where we have used the symmetry in the ‘per’ and ‘exchange’ currencies. In order to isolate better the contribution of one currency, the currency pairs basket should be as large as possible. For example, for the USD, contribution from other Asiatic currencies and from central and South-American currencies (Mexican pesos, Brasilian Real) can also be included.

Finally, the single currency indices S can be summed to obtain a world index, reflecting the total currency turbulences in the worldwide FX markets. Each contributing currency is weighted according to its estimated relative importance.

2.9 Forecasting Price Movements

Let us emphasize that both scales of market shocks are designed as indicators: they provide a diagnostic tool about the past behavior of the price movements. They can be seen as measuring a ‘state’ of the market and they allow to compare states for different times and assets. In order to have a fast enough response, the integration measure is centered at one day volatility, corresponding to a sum of squared returns measured on price movements over 1.5 hours. These short time intervals result in the indicators having a quick intra day response, and an accurate localization in time of the events. We find a good illustration of this behavior in the exceptionally strong price movement of USD/JPY during the week of Oct. 5-9, 1998. The movement was of more than 15% in one week, the largest weekly movement recorded in our database, and happened in two consecutive shocks, one on October 7th and one on October 8th. The SMS moved from a value of below 3 to a value above 10 in a few hours before the movement was completed thus giving an early warning that the situation was very unstable.

Accordingly, the scale of market shocks is also a forecast of volatility. It is interesting to measure the relation between the SMS and the size of the next price movement to assess its capacity to detect possible risky situations. Therefore, we measure the linear correlation coefficient between the universal SMS and the absolute value of the next return. Essentially, this is similar to a correlation between past and future volatilities. In order to compare the result to a reference curve, we do a similar computation with a volatility model a la RiskMetrics [Morgan Guaranty, 1996]. In order to obtain a high frequency volatility similar to RiskMetrics, we compute

υ_{RiskMetrics}=\sqrt{EMA[T;(D[τ;x])²]}. (9.21)

with τ=7/5 days, T=7/5*16.16 days, and 16.16 days=−1/ln(0.94). The operators are described in detail in [Zumbach and Muller, 2000]. The computations are done in theta time to remove the seasonalities, and 7/5 is the conversion factor of one physical day into one business day. The original RiskMetrics definition is based on daily prices, our definition uses high-frequency data. We thus expect our measure of volatility to be slightly better than the original RiskMetrics measure. Note that the RiskMetrics parameter 0.94 was optimized to provide the best one day volatility forecast.

The linear correlation coefficient is given in FIG. 8 for both models. Clearly, the SMS is a good leading indicator for the size of the next price movements, particularly for the very short time horizons where the correlation coefficient reaches 0.4 for 4 hours movements. The SMS has a larger correlation than RiskMetrics (by about 13% for 4 hours) up to one day, and a slightly lower correlation for longer return time intervals. This is to be expected given the different time characteristics of the two indicators. A rapid test for a SMS centered at roughly the same time horizon as RiskMetrics (16 days) shows a better correlation for the SMS than for the RiskMetrics volatility. This confirms that our formalism is able to catch risky situations and the return heteroskedasticity, although its main purpose is to be able to quantify and compare current price movements.

2.10 Conclusion

By analogy with the Richter scale in geology, we suggest defining two scales of market shocks based on volatilities of financial asset measured at different frequencies. A careful design of these scales enable us to extract from the price time series the major events happening on the markets. In a simple event study for USD/JPY and USD/DEM over the last 21 months, we observe that the SMS indexes measure well the market evolution, breaks or crises in Europe, USA and Asia during this period. Therefore, the SMS indices allow us to measure in an objective way the relative impact of different news and events on the overall foreign exchange market. Moreover, the scales for all FX-rates related to a given currency can be combined into a single currency scale which, in turn, can be combined into a general world scale for the FX market.

The definition of the SMS is a mandatory step in evaluating the current state of financial markets, and it allows us to quantify in an objective way events and crises. The SMS measured across multiple assets, and some natural combination of them, would let us assess the extent and severity of a crisis. An analysis of the correlation coefficient between the universal SMS and the following absolute return shows that the SMS can already be used as an indication of market instabilities in the near future. Thus, the SMS has a better forecast of possible future crises, and therefore, provides an early warning about potential turmoil on financial markets.

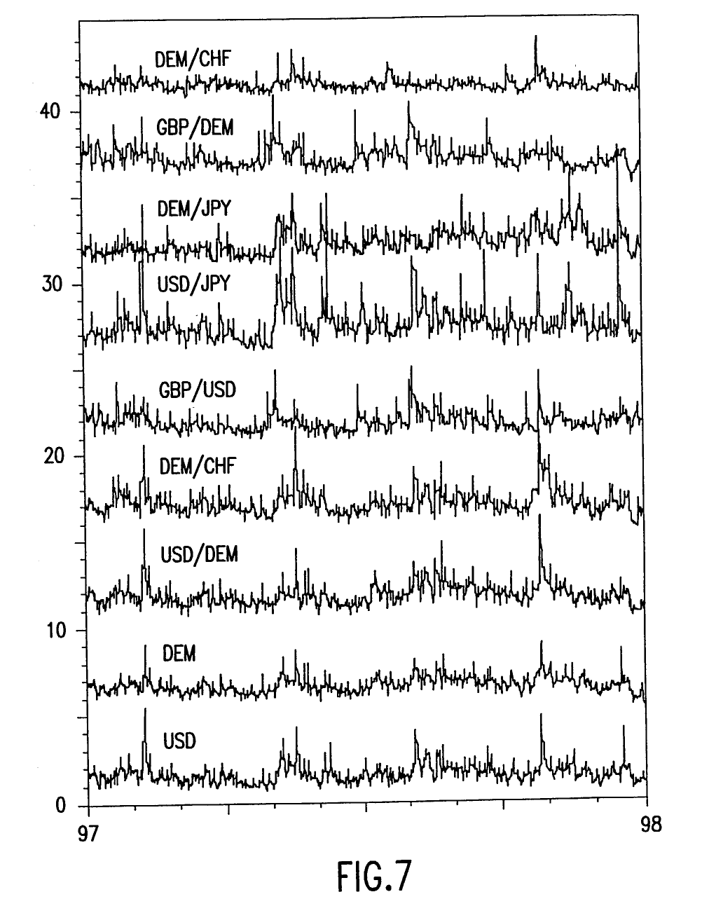

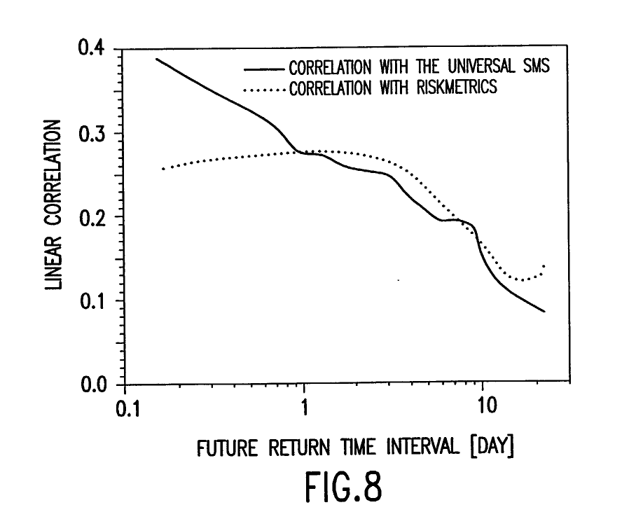

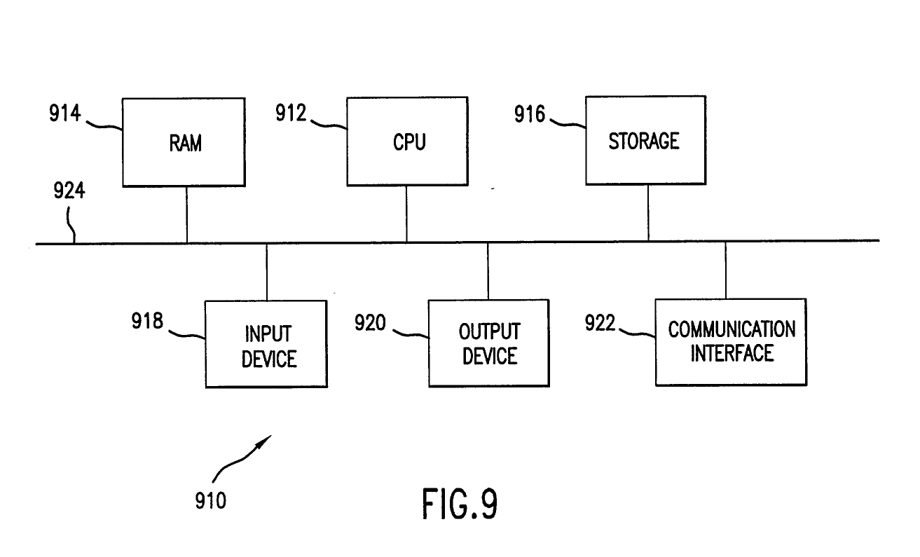

FIG. 9 discloses a representative computer system 910 in conjunction with which the embodiments of the present invention may be implemented. Computer system 910 may be a personal computer, workstation, or a larger system such as a minicomputer. However, one skilled in the art of computer systems will understand that the present invention is not limited to a particular class or model of computer.

As shown in FIG. 9, representative computer system 910 includes a central processing unit (CPU) 912, a memory unit 914, one or more storage devices 916, an input device 918, an output device 920, and communication interface 922. A system bus 924 is provided for communications between these elements. Computer system 910 may additionally function through use of an operating system such as Windows, DOS, or UNIX. However, one skilled in the art of computer systems will understand that the present invention is not limited to a particular configuration or operating system.

Storage devices 916 may illustratively include one or more floppy or hard disk drives, CD-ROMs, DVDs, or tapes. Input device 918 comprises a keyboard, mouse, microphone, or other similar device. Output device 910 is a computer monitor or any other known computer output device. Communication interface 922 may be a modem, a network interface, or other connection to external electronic devices, such as a serial or parallel port

While the above invention has been described with reference to certain preferred embodiments, the scope of the present invention is not limited to these embodiments. One skilled in the art may find variations of these preferred embodiments which, nevertheless, fall within the spirit of the present invention, whose scope is defined by the claims set forth below.

### References

[Almeida et al., 1998] Almeida A., Goodhart C., and Payne R., 1998, The effects of macroeconomic news on high frequency exchange rate behavior, Journal of Financial and Quantitative Analysis, 33(3), 383-408.

[Andersen and Bollerslev, 1997] Andersen T. G. and Bollerslev T., 1997, Intraday periodicity and volatility persistence in financial markets, Journal of Empirical Finance, 4(2-3), 115-158.

[Baillie and Bollerslev, 1990] Baillie R. T. and Bollerslev T., 1990, Intra day and inter market volatility in foreign exchange rates, Review of Economic Studies, 58, 565-585.

[Dacorogna et al., 1993] Dacorogna M. M., Müller U. A., Nagler H.. J., Olsen H. B., and Pictet 0. V., 1993, A geographical model for the daily and weekly seasonal volatility in the EX market, Journal of International Money and Finance, 12(4), 413-438.

[Ding et al., 1993] Ding Z., Granger C. W. J., and Engle R. F., 1993, A long memory property of stock market returns and a new model, Journal of Empirical Finance, 1, 83-106.

[Drost and Nijman, 1993] Drost F. and Nijman T., 1993, Temporal aggregation of garch processes, Econometrica, 61, 909-927.

[Guillaume et al., 1994] Guillaume D. M., Dacorogna M. M., and Pictet O. V., 1994, On the intra-daily performance of garch processes, Poster presented at the First International Conference on High Frequency Data in Finance, Zurich.

[Hsieh, 1988] Hsieh D. A., 1988, The statistical properties of daily foreign exchange rates: 1974-1983, Journal of International Economics, 24, 129-145.

[Mandelbrot, 1963] Mandelbrot B. B., 1963, The variation of certain speculative prices, Journal of Business, 36, 394-419.

[Morgan Guaranty, 1996] Morgan Guaranty, 1996, RiskMetrics™—Technical Document, Morgan Guaranty Trust Company of New York, New York, 4th edition.

[Müller et al., 1997] Müller U. A., Dacorogna M. M., Dav4 H. D., Olsen H.. B., Pictet O. V., and von Weizsacker J. E., 1997, Volatilities of different time resolutions - analyzing the dynamics of market components, Journal of Empirical Finance, 4(2-3), 213-239.

[Müller et al., 1990] Müller U. A., Dacorogna M. M., Olsen H.. B., Pictet O. V., Schwarz M., and Morgenegg C., 1990, Statistical study of foreign exchange rates, empirical evidence of a price change scaling law, and intraday analysis, Journal of Banking and Finance, 14, 1189-1208.

[Müller et al., 1998] Müller U. A., Dacorogna M. M., and Pictet O. V., 1998, Heavy tails in high-frequency financial data, published in the book “A practical guide to heavy tails: Statistical Techniques for Analysing Heavy Tailed Distributions”, edited by Robert 3. Adler, Raisa E. Feldman and Murad S. Taqqu and published by Birkhauser, Boston 1998, 55-77.

[Richter, 1958] Richter C. F., 1958, Elementary Seismology, Freeman, San Francisco.

[Taylor, 1986] Taylor S. J., 1986, Modelling Financial Time Series, 3. Wiley & Sons, Chichester.

[Zumbach and Müller, 2000] Zumbach G. O. and Müller U. A., 2000, Operators on inhomogeneous time series, to be published in International Journal of Theoretical and Applied Finance.

What is claimed is:

1. A system for measuring at least one market condition from at least one time series comprising:
one or more time horizons;
a measure fixing one or more weights of one or more contributions of said one or more time horizons from the time series;
an expression of volatility of the time series defined over said one or more time horizons;
a mapping of said expression of volatility over said one or more time horizons; and
an integral, taken over said one or more time horizons, of the product of said measure and said mapping for measuring the at least one market condition.

2. A system for measuring at least one market condition from at least one time series as in claim 1 wherein the time series comprises a plurality of ticks, each of said ticks comprises a (time stamp, price) pair.

3. A system for measuring at least one market condition from at least one time series system as in claim 2 wherein said price in each of said ticks is a logarithmic middle price of a bid price and an ask price.

4. A system for measuring at least one market condition from at least one time series system as in claim 1 wherein said expression of volatility comprises an exponential moving average.

5. A system for measuring at least one market condition from at least one time series as in claim 1 wherein said expression of volatility comprises a probability density function of volatility defined over said one or more time horizons.

6. A system for measuring at least one market condition from at least one time series as in claim 5 wherein said probability density function is a log-normal distribution.

7. A system for measuring at least one market condition from at least one time series as in claim 1 wherein said measure comprises a function centered at a predetermined one of said time horizons.

8. A system for measuring at least one market condition from at least one time series as in claim 7 wherein said function decays from said predetermined time horizon to longer and shorter ones of said time horizons.

9. A system for measuring at least one market condition from at least one time series as in claim 7 wherein said predetermined time horizon is one day.

10. A system for measuring at least one market condition from at least one time series as in claim 1 wherein said integral taken over said time horizons has a low limit of one hour.

11. A system for measuring at least one market condition from at least one time series as in claim 1 wherein said integral taken over said time horizons has a high limit of 42 days.

12. A system for measuring at least one market condition from at least one time series as in claim 5 wherein said mapping has a form that is defined as:
$$sign ( v - {v}_{max} ) ln ( \frac{{p}_{max}}{p ( v )} )$$
wherein:
υ is said volatility,
υₘₐₓ is where the maximum of said probability density function of said volatility is reached,
p(υ) is said probability density function, and
pₘₐₓ is the maximum of said probability density function of said volatility.

13. A system for measuring at least one market condition from at least one time series as in claim 1 wherein said mapping is a linear mapping of said volatility.

14. A system for measuring at least one market condition from at least one time series as in claim 1 wherein the at least one market condition is at least one market stability.

15. A system for measuring at least one market condition from at least one time series as in claim 1 wherein the time series is a time series of a foreign exchange market of a plurality of currencies and wherein said integral is a currency pair index S[per/exchanged] measuring a market condition between a currency pair (per, exchanged) of a first one of said currencies, per, and a second one of said currencies, exchanged.

16. A system for measuring at least one market condition from at least one time series as in claim 15 further comprising an index S[per] for said per currency, wherein said index S[per] is defined as a summation of said currency pair index S[per/exchanged] taken over a group of said exchanged currencies.

17. A system for measuring at least one market condition from at least one time series as in claim 16 further comprising a world index defines as a summation of said index S[per] over said plurality of currencies.

18. A system for measuring at least one market condition from at least one time series as in claim 16 wherein said summation is weighted for estimating relative importances of said currency pairs.

19. A system for measuring at least one market condition from at least one time series as in claim 17 wherein said summation taken over said plurality of currencies is weighted for estimating relative importances of said plurality of currencies.

20. A method for measuring at least one market condition from at least one time series comprising the steps of:
defining one or more time horizons;
defining a measure fixing one or more weights of one or more contributions of said one or more time horizons from the time series;
defining an expression of volatility of the time series defined over said one or more time horizons;
defining a mapping of said expression of volatility over said one or more time horizons; and
determining an integral, taken over said one or more time horizons, of the product of said measure and said mapping for measuring the at least one market condition.

21. Computer executable software code stored on a computer readable medium, the code for measuring at least one market condition from at least one time series, the code comprising:
code to define one or more time horizons;
code to define a measure fixing one or more weights of one or more contributions of said one or more time horizons from the time series;
code to define an expression of volatility of the time series defined over said one or more time horizons;
code to define a mapping of said expression of volatility over said one or more time horizons; and
code to determine an integral, taken over said one or more time horizons, of the product of said measure and said mapping for measuring the at least one market condition.

22. A programmed computer system for measuring at least one market condition from at least one time series, comprising at least one memory having at least one region storing computer executable program code and at least one processor for executing the program code stored in said memory, wherein the program code includes
code to define one or more time horizons;
code to define a measure fixing one or more weights of one or more contributions of said one or more time horizons from the time series;
code to define an expression of volatility of the time series defined over said one or more time horizons;
code to define a mapping of said expression of volatility over said one or more time horizons; and
code to determine an integral, taken over said one or more time horizons, of the product of said measure and said mapping for measuring the at least one market condition.
